(19) United States
(12) Patent Application Publication
(10) Pub. No.: US 2024/0375233 A1
(43) Pub. Date: Nov. 14, 2024

(54) CONTROL DEVICE, INDUSTRIAL MACHINE, AND CONTROL METHOD

(71) Applicant: KOMATSU LTD., Tokyo (JP)

(72) Inventors: Kenichi BANDOH, Tokyo (JP); Mohammad MUNZIR, Tokyo (JP); Natsuki ITOU, Tokyo (JP); Shouichi DAIKU, Tokyo (JP); Masashi OSANAI, Tokyo (JP); Toshiki MAEDA, Tokyo (JP)

(21) Appl. No.: 18/690,500

(22) PCT Filed: Oct. 28, 2022
(86) PCT No.: PCT/JP2022/040554

§ 371 Date: Mar. 8, 2024

(30) Foreign Application Priority Data
Oct. 29, 2021 (JP) 2021-177961

(51) Int. Cl. B23Q 17/22; B23Q 17/24; G05B 19/404

(52) U.S. Cl. CPC B23Q 17/2291; B23Q 17/2409; G05B 19/404; G05B 2219/50289

(57) ABSTRACT

A relative displacement-specifying unit specifies relative displacement between a jig and tool based on measurement values of displacements of the tool and jig. A position determination unit determines whether the jig and the tool are positioned at jig and tool calibration points based on the measurement values. A displacement correction unit corrects the measurement values based on captured images of the jig and tool calibration points when it is determined that the jig and the tool are positioned at the calibration points. A contact determination unit determines whether the tool contacts the workpiece based on a measurement value related to main shaft flexure. A tool data correction unit corrects tool data based on the relative displacement when it is determined that the tool contacts the workpiece. A control unit generates a control command to control the jig or the tool based on the relative displacement, workpiece shape, and tool data.

### CROSS-REFERENCE TO RELATED APPLICATIONS

This application is a U.S. National stage application of International Application No. PCT/JP2022/040554, filed on Oct. 28, 2022. This U.S. National stage application claims priority under 35 U.S.C. § 119 (a) to Japanese Patent Application No. 2021-177961, filed in Japan on Oct. 29, 2021, the entire contents of which are hereby incorporated herein by reference.

### BACKGROUND

### Technical Field

The present disclosure relates to a control device, an industrial machine, and a control method.

### Background Information

Japanese Unexamined Patent Application, First Publication No. 2006-159299, discloses a technique of using a tool of an industrial machine as a shape-measuring probe. Specifically, Japanese Unexamined Patent Application, First Publication No. 2006-159299, discloses a technique of applying vibration to the tool and determining that the tool has come into contact with an object when a force sensor attached to the tool detects the vibration.

### SUMMARY

In order to improve machining accuracy of a workpiece by a machine such as an industrial machine, it is desired to correct a machining error while machining the workpiece.

An object of the present disclosure is to provide a control device, an industrial machine, and a control method capable of correcting a machining error while machining a workpiece.

According to a first aspect of the present invention, a control device of a machine, the machine including a jig and a main shaft, the jig being configured to support a workpiece, the main shaft including a tool that machines the workpiece, the control device includes: a relative displacement-specifying unit configured to specify a relative displacement between the jig and the tool based on measurement values of displacements of the jig and the tool; a position determination unit configured to determine whether the jig and the tool are respectively positioned at a jig calibration point and a tool calibration point based on the measurement values of the displacements of the jig and the tool; a displacement correction unit configured to correct the measurement values of the displacements of the jig and the tool based on a captured image of the jig calibration point and a captured image of the tool calibration point imaged by a camera supported by a support that does not come into contact with the machine when it is determined that the jig and the tool are respectively positioned at the jig calibration point and the tool calibration point; a contact determination unit configured to determine whether the tool comes into contact with the workpiece based on a measurement value related to flexure of the main shaft; a tool data correction unit configured to correct tool data indicating a length of the tool based on the relative displacement when it is determined that the tool comes into contact with the workpiece; and a control unit configured to generate a control command for controlling the jig or the tool based on the relative displacement, a shape of the workpiece, and the tool data.

According to a second aspect of the present invention, a control device of a machine, the machine including a jig and a main shaft, the jig being configured to support a workpiece, the main shaft including a tool that machines the workpiece and a head that supports the tool, the control device includes: a relative displacement-specifying unit configured to specify a relative displacement between the jig and the tool based on measurement values of displacements of the jig and the tool; a contact determination unit configured to determine whether the tool comes into contact with the workpiece based on a measurement value related to flexure of the main shaft; a tool data correction unit configured to correct tool data indicating a length of the tool based on the relative displacement when it is determined that the tool comes into contact with the workpiece; and a control unit configured to generate a control command for controlling the jig or the tool based on the relative displacement, a shape of the workpiece, and the tool data. The head is provided with a hinge member connecting a distal portion and a proximal portion of the head to each other, and a strain sensor provided to straddle a rotation axis of the hinge member. The contact determination unit determines whether the tool comes into contact with the workpiece based on a measurement value of the strain sensor.

According to the above aspects, the control device can correct a machining error while machining a workpiece.

### BRIEF DESCRIPTION OF DRAWINGS

FIG. 1 is a perspective view showing an appearance of a machining center according to a first embodiment.

FIG. 2 is a perspective view showing a configuration inside a housing of a machine main body according to the first embodiment.

FIG. 3 is a schematic diagram showing a configuration of a main shaft head according to the first embodiment.

FIG. 4 is a schematic block diagram showing a configuration of a control board according to the first embodiment.

FIG. 5 is a diagram showing an example of a locus of a tool in a cutting direction according to the first embodiment.

FIG. 6 is a diagram showing an example of a locus of the tool in a feed direction according to the first embodiment.

FIG. 7 is a flowchart showing a calibration operation of the control board according to the first embodiment.

FIG. 8 is a flowchart showing a machining operation by the control board according to the first embodiment.

FIG. 9 is a diagram showing an example of a display image according to the first embodiment.

FIG. 10 is a graph showing the relationship between measurement values of a torque and flexure and a calculated value of stiffness.

FIG. 11 is a diagram showing an example of side machining of a workpiece.

FIG. 12 is a diagram showing measurement results of a machining error of the workpiece by the side machining.

FIG. 13 is a schematic block diagram showing a configuration of a computer according to at least one embodiment.

### DETAILED DESCRIPTION OF EMBODIMENT(S)

### First Embodiment

### (Configuration of Machining Center 1)

Hereinafter, embodiments will be described in detail with reference to the drawings.

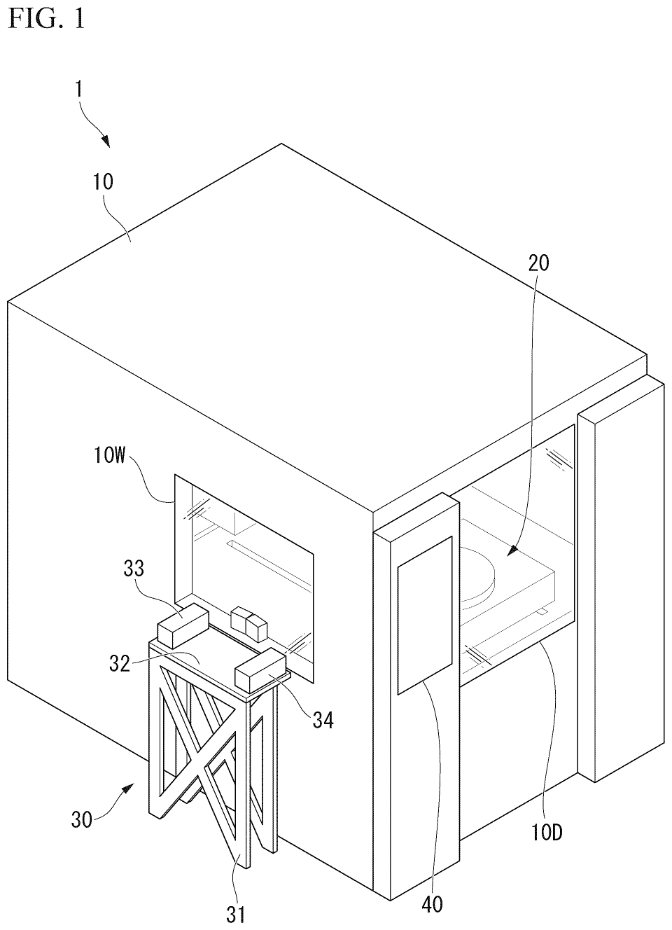

FIG. 1 is a perspective view showing an appearance of a machining center 1 according to a first embodiment. The machining center 1 includes a machine main body 20, an imaging device 30, and a control board 40.

The machine main body 20 includes a housing 10 that forms an outer shell thereof. The housing 10 is configured to cover the machine main body 20 in order to prevent scattering of chips or coolant caused by machining of a workpiece by the machine main body 20. A door 10D is provided on a front surface of the housing 10. A window 10W is provided on a side surface of the housing 10.

The imaging device 30 includes a pedestal 31, a top plate 32, a head camera 33, and a table camera 34. The pedestal 31 is placed on a floor surface. The pedestal 31 and the housing 10 do not come into contact with each other, and a space is provided between the pedestal 31 and the housing 10. The top plate 32 is provided in the upper end of the pedestal 31. The pedestal 31 supports the top plate 32. It is preferable that the top plate 32 be formed of a material that is less likely to thermally expand. An example of a material that is less likely to thermally expand includes ceramics or the like. The top plate 32 is provided with holes for attaching the head camera 33 and the table camera 34 thereto. The top plate 32 is provided not to come into contact with the housing 10. Accordingly, the pedestal 31 and the top plate 32 can maintain the positions of the head camera 33 and the table camera 34 even when the machine main body 20 vibrates due to the operation of the machine main body 20.

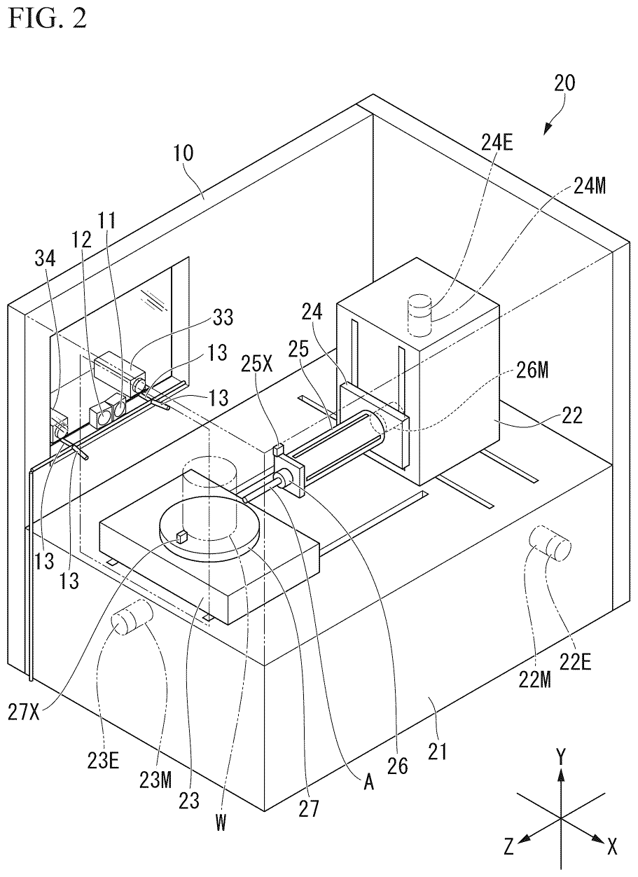

FIG. 2 is a perspective view showing a configuration inside the housing 10 of the machine main body 20 according to the first embodiment.

The machine main body 20 includes a base 21, a column 22, and a table 23 inside the housing 10. The column 22 and the table 23 are provided on an upper surface of the base 21.

The column 22 is provided movably in an X-axis direction set to be parallel to the upper surface of the base 21. The base 21 is provided with an X-axis motor 22M and an X-axis encoder 22E. The X-axis motor 22M is an actuator for moving the column 22 along the X-axis. The rotation of the X-axis motor 22M is converted into linear motion by a ball screw mechanism (not shown). The X-axis encoder 22E measures the amount of movement of the column 22.

A slider 24 is attached to the column 22. The slider 24 is arranged on a side portion of the column 22 on the table 23 side and is provided movably in a Y-axis direction orthogonal to both of the X-axis and a Z-axis. The column 22 is provided with a Y-axis motor 24M and a Y-axis encoder 24E. The Y-axis motor 24M is an actuator for moving the slider 24 along the Y-axis. The rotation of the Y-axis motor 24M is converted into linear motion by a ball screw mechanism (not shown). The Y-axis encoder 24E measures the amount of movement of the slider 24.

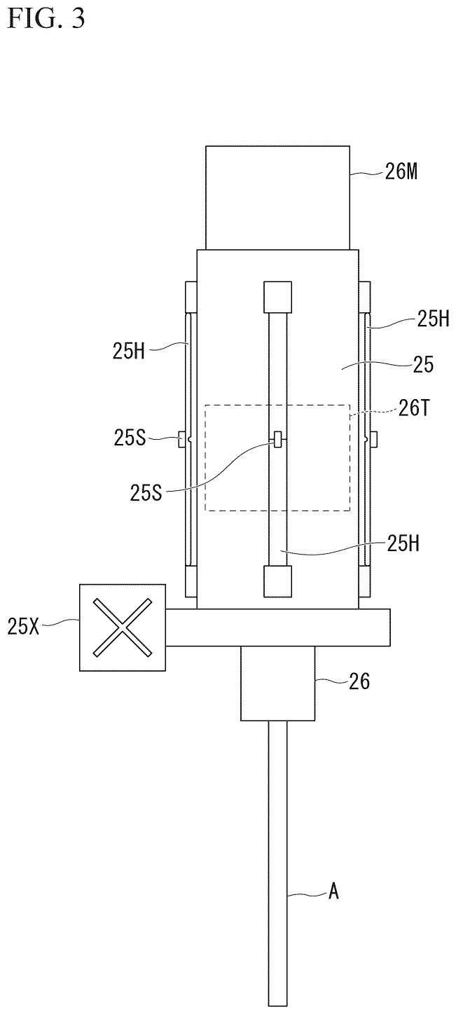

A main shaft head 25 is attached to a surface of the slider 24 on the table 23 side. A head tab 25X in which a predetermined mark is drawn on a side surface thereof is fixedly provided on an upper surface of the main shaft head 25. The mark of the head tab 25X is drawn on a surface of the head tab 25X facing the window 10W. As shown in FIG. 3, for example, an X mark is drawn on the head tab 25X. The mark of the head tab 25X is not limited to the X mark, and any shape that can specify the center position and angle may be used therefor. The main shaft head 25 supports a spindle 26 rotatably on a rotation axis parallel to the Z-axis. The main shaft head 25 itself does not rotate. A tool A is mounted on the spindle 26. An example of the tool A includes a milling cutter or the like. The spindle 26 is provided with a spindle motor 26M for rotating the spindle 26. The tool A is attached to the spindle 26 by a user and is replaceable. The tool A may be automatically replaced by the function of the machining center 1. Hereinafter, the entire portion including the main shaft head 25, the spindle 26, and the tool A and extending in the Z-axis direction to be moved by the slider 24 is also referred to as a main shaft.

FIG. 3 is a schematic diagram showing a configuration of the main shaft head 25 according to the first embodiment. FIG. 3 is a view of the main shaft head 25 as viewed from the window 10W side. Four elastic hinges 25H are attached to the main shaft head 25. The elastic hinge 25H is a strip-shaped member formed of an elastic material and is provided with notches extending in a width direction on a front surface or a back surface at both ends and a central portion in a long side direction. The elastic hinge 25H functions as a hinge by bending at the notch as a fulcrum. The elastic hinge 25H is attached to a side surface of the main shaft head 25 such that the long side direction is parallel to the axial direction of the main shaft head 25. Both ends of the elastic hinge 25H in the long side direction are fixed to the main shaft head 25. As a result, the bending angle of the central portion of the elastic hinge 25H changes according to the flexure or compression of the main shaft head 25. The elastic hinge 25H is formed of the same material as that of the main shaft head 25 or a material having the same linear expansion coefficient as that of the main shaft head 25. The four elastic hinges 25H are attached to the upper surface, the lower surface, and both side surfaces of the main shaft head 25. In another embodiment, the main shaft head 25 may include three or more elastic hinges 25H. By providing three or more elastic hinges 25H, the strain of the main shaft head 25 in at least the X-axis direction and the Y-axis direction can be specified.

A strain sensor 25S is attached to a surface, without the notch, of the central portion of each elastic hinge 25H. The strain sensor 25S outputs a measurement value according to the bending angle of the central portion of the elastic hinge 25H. The bending angle of the central portion of the elastic hinge 25H changes according to the flexure or compression of the main shaft head 25, so the strain sensor 25S measures the amount related to the flexure of the main shaft head 25. The flexure of the main shaft head 25 in a left-right direction is obtained from a magnitude of strain of the elastic hinges 25H attached to both side surfaces of the main shaft head 25. The flexure of the main shaft head 25 in an up-down direction is obtained from a magnitude of strain of the elastic hinges 25H attached to the upper surface and the lower surface of the main shaft head 25.

The main shaft head 25 is provided with a torque sensor 26T for measuring the torque of the spindle motor 26M. In another embodiment, the machine main body 20 may not include the torque sensor 26T. In this case, the control board 40 can specify the torque of the spindle motor 26M based on the torque command or the current command for the spindle motor 26M.

As shown in FIG. 2, the table 23 is provided movably in the Z-axis direction parallel to the upper surface of the base 21 and orthogonal to the X-axis. A work table 27 is attached to an upper portion of the table 23. The work table 27 is a jig that supports a workpiece W that is an object to be machined. A table tab 27X in which a predetermined mark is drawn on a side surface thereof is fixedly provided on an upper surface of the work table 27. The mark of the table tab 27X is drawn on the surface of the table tab 27X facing the window 10W. The mark of the table tab 27X is represented by, for example, an X mark. The mark of the table tab 27X is not limited to the X mark, and any mark that can specify the center position and angle may be used therefor. The table tab 27X is provided in a portion of the table 23 where the workpiece W is not placed. The base 21 is provided with a Z-axis motor 23M and a Z-axis encoder 23E. The Z-axis motor 23M is an actuator for moving the table 23 along the Z-axis. The rotation of the Z-axis motor 23M is converted into linear motion by a ball screw mechanism (not shown). The Z-axis encoder 23E measures the amount of movement of the table 23.

As shown in FIG. 2, the head camera 33 of the imaging device 30 is provided such that an optical axis passes through the center of the head tab 25X of the main shaft head 25 via the window 10W when the column 22 and the slider 24 are positioned at predetermined calibration points. The calibration point at which the column 22 is to be positioned is also referred to as a column calibration point. The calibration point at which the slider 24 is to be positioned is also referred to as a slider calibration point. When the column 22 is positioned at the column calibration point and the slider 24 is positioned at the slider calibration point, the main shaft head 25 is positioned at a tool calibration point.

The table camera 34 is provided such that an optical axis passes through the center of the table tab 27X of the work table 27 via the window 10W when the table 23 is positioned at a predetermined calibration point. The calibration point at which the table 23 is to be positioned is also referred to as a table calibration point. When the table 23 is positioned at the table calibration point, the work table 27 is positioned at a jig calibration point.

A headlight 11, a table light 12, and four air nozzles 13 are provided inside the housing 10 in the vicinity of the window 10W.

The headlight 11 irradiates the head tab 25X with light. The table light 12 irradiates the table tab 27X with light. The air nozzles 13 inject air toward a portion of the window 10W in front of the head camera 33, a portion of the window 10W in front of the table camera 34, the head tab 25X, and the table tab 27X. As a result, it is possible to remove coolant or chips that block the optical axes of the head camera 33 and the table camera 34 and to remove coolant or chips adhering to the head tab 25X and the table tab 27X. The number of air nozzles 13 according to another embodiment is not limited to four. For example, a machining center 1 according to another embodiment may include five or more air nozzles 13 to remove an obstacle on an optical axis of a camera. A machining center 1 according to further another embodiment may not include some or all of the four air nozzles 13.

### (Configuration of Control Board 40)

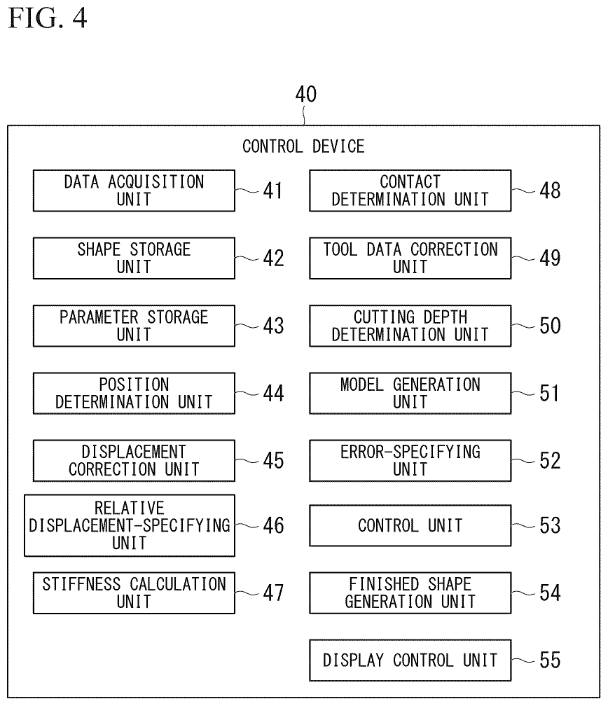

FIG. 4 is a schematic block diagram showing a configuration of the control board 40 according to the first embodiment. The control board 40 controls various actuators of the machine main body 20 based on measurement data of the machine main body 20. The control board 40 is provided on an operation panel to be operated by an operator, for example, as shown in FIG. 1.

The control board 40 includes a data acquisition unit 41, a shape storage unit 42, a parameter storage unit 43, a position determination unit 44, a displacement correction unit 45, a relative displacement-specifying unit 46, a stiffness calculation unit 47, a contact determination unit 48, a tool data correction unit 49, a cutting depth determination unit 50, a model generation unit 51, an error-specifying unit 52, a control unit 53, a finished shape generation unit 54, and a display control unit 55.

The data acquisition unit 41 acquires measurement data from various sensors of the machine main body 20. Specifically, the data acquisition unit 41 acquires measurement data from the X-axis encoder 22E, the Z-axis encoder 23E, the Y-axis encoder 24E, the strain sensor 25S, and the torque sensor 26T. The data acquisition unit 41 also acquires image data from the head camera 33 and the table camera 34. The data acquisition unit 41 acquires the flexure of the main shaft head 25 in the left-right direction that is obtained from the magnitude of strain of the elastic hinges 25H attached to both side surfaces of the main shaft head 25. The data acquisition unit 41 acquires the flexure of the main shaft head 25 in the up-down direction that is obtained from the magnitude of strain of the elastic hinges 25H attached to the upper surface and the lower surface of the main shaft head 25. The magnitude of the flexure may be acquired by calculation of the data acquisition unit 41 or may be acquired from a circuit that processes signals output by the plurality of strain sensors 25S.

The shape storage unit 42 stores target shape data that is three-dimensional data representing the target shape of the workpiece W, initial shape data that is three-dimensional data representing the initial shape of the workpiece W, and machining shape data that is three-dimensional data representing the shape of the workpiece W after machining. The target shape data and the initial shape data are input in advance by the user of the machine main body 20. The initial value of the machining shape data is the same as the initial shape data.

The parameter storage unit 43 stores parameters to be used for control of the machine main body 20 by the control unit 53. Specifically, the parameter storage unit 43 stores a relative displacement offset, tool data, and a state model. The relative displacement offset is a correction value for the relative displacement between the main shaft head 25 and the work table 27 obtained from the measurement data of the encoders. The relative displacement may not only include a translation amount but may also include a rotation angle. The relative displacement may be represented by a Y-axis component and a Z-axis component of the distance between the center point of the head tab 25X and the center point of the table tab 27X. The rotation angle may be represented by an angle between a straight line extending from the center point of the head tab 25X to a feature point (for example, an upper right protrusion portion of the X mark) of the head tab 25X and a straight line extending from the center point of the table tab 27X to a feature point of the table tab 27X. The tool data is data representing the shape of the tool A including the length (i.e., tool length) of the tool A attached to the spindle 26. The tool data may include the diameter of the tool A. The state model is a function that predicts machining errors caused by the state of the machine main body 20 during machining of the workpiece W. An example of the state of the machine main body 20 during machining includes the flexure of the main shaft or the like.

The position determination unit 44 determines whether the main shaft head 25 and the work table 27 are positioned at predetermined calibration points in terms of calculation based on the measurement data of the X-axis encoder 22E, the Z-axis encoder 23E, and the Y-axis encoder 24E acquired by the data acquisition unit 41. Even when it is determined that the main shaft head 25 and work table 27 are positioned exactly at the calibration points in terms of calculation, the actual positions of the main shaft head 25 and work table 27 may not match the calibration points due to encoder measurement errors or the like. Also in this case, the main shaft head 25 and the work table 27 are positioned at least in the vicinity of the calibration points. The vicinity is a range in which the head tab 25X and the table tab 27X are respectively positioned within the imaging ranges of the head camera 33 and the table camera 34.

The displacement correction unit 45 moves the main shaft head 25 and work table 27 to the calibration points based on the image data of the head camera 33 and table camera 34. The displacement correction unit 45 updates the relative displacement offset stored in the parameter storage unit 43 based on the values of the X-axis encoder 22E, the Z-axis encoder 23E, and the Y-axis encoder 24E when the main shaft head 25 and the work table 27 are positioned at the calibration points.

The relative displacement-specifying unit 46 specifies the relative displacement between the main shaft head 25 and the work table 27 based on the measurement data of the X-axis encoder 22E, the Z-axis encoder 23E, and the Y-axis encoder 24E, and the relative displacement offset stored in the parameter storage unit 43. For example, the relative displacement-specifying unit 46 specifies the position of the main shaft head 25 when the center point of the upper surface of the work table 27 is used as a reference.

The stiffness calculation unit 47 calculates the stiffness of the main shaft based on the measurement data of the strain sensor 25S and the torque sensor 26T. Specifically, the stiffness K is calculated according to the following Equation (1).

$$\begin{matrix}( Equation 1 ) & \\ K = \frac{T}{\vert ε \vert + δ} sign ( ε ) & ( 1 )\end{matrix}$$

T is the measurement value of the torque sensor 26T. ε represents the flexure of the main shaft obtained based on the measurement value of the strain sensor 25S. ε theoretically becomes zero when there is no flexure of the tool A. δ is a predetermined minute value. The minute value δ is set such that a solution for the stiffness K can be obtained even when the flexure ε is zero. sign (¿) is a function representing the sign of the flexure ε.

The contact determination unit 48 determines whether the tool A comes into contact with the workpiece W based on the stiffness value calculated by the stiffness calculation unit 47. The flexure & of the main shaft is theoretically zero when the tool A does not come into contact with the workpiece W, so the stiffness value calculated by the Equation (1) diverges. Meanwhile, when the tool A comes into contact with the workpiece W, the flexure ε of the main shaft is no longer zero, so the stiffness value calculated by the Equation (1) converges. Therefore, the contact determination unit 48 determines that the tool A comes into contact with the workpiece W when the stiffness value calculated by the stiffness calculation unit 47 converges from the divergent state.

The tool data correction unit 49 specifies the tool length based on the relative displacement between the main shaft head 25 and the work table 27 when it is determined that the tool A comes into contact with the workpiece W, and the initial shape data stored in the shape storage unit 42. Specifically, the tool data correction unit 49 specifies the tool length in the following procedure. The tool data correction unit 49 obtains a height (Z-axis value) of a point where the workpiece W directly faces the tool A based on the values of the X-axis and Y-axis components in the relative displacement between the main shaft head 25 and the work table 27. The tool length is specified by subtracting the height of the point where the workpiece W directly faces the tool A from the value of the Z-axis component in the relative displacement between the main shaft head 25 and the work table 27.

The cutting depth determination unit 50 calculates a cutting depth of the workpiece W based on the relative displacement between the main shaft head 25 and the work table 27 specified by the relative displacement-specifying unit 46 and the target shape data stored in the shape storage unit 42. For example, the cutting depth is calculated by using a difference between the tool length or tool diameter of a tool to be used and a cutting depth of a reference tool having a predetermined tool length or tool diameter. In calculating the cutting depth, any one or both of the tool length and the tool diameter may be used depending on the type of the tool.

The model generation unit 51 updates the state model stored in the parameter storage unit 43 based on the cutting depth calculated by the cutting depth determination unit 50 and the measurement data of the strain sensor 25S. The state model includes a flexure model that outputs the flexure of the main shaft with the cutting depth as an input. The state model will be described later.

The error-specifying unit 52 converts the magnitude of the flexure of the main shaft into the amount of deviation of the position of the tool A, that is, an amount of uncut portion by using the state model stored in the parameter storage unit 43. That is, the error-specifying unit 52 specifies the machining error caused by the flexure.

The control unit 53 corrects the cutting depth determined by the cutting depth determination unit 50 so as to cancel the error calculated by the error-specifying unit 52, and generates a control signal for each actuator based on the tool length stored in the parameter storage unit 43.

The finished shape generation unit 54 generates three-dimensional data indicating the shape of the workpiece W to be machined based on the measurement data of the X-axis encoder 22E, the Z-axis encoder 23E, the Y-axis encoder 24E, and the strain sensor 25S.

The display control unit 55 outputs the generated three-dimensional data to a display or the like.

### (State Model)

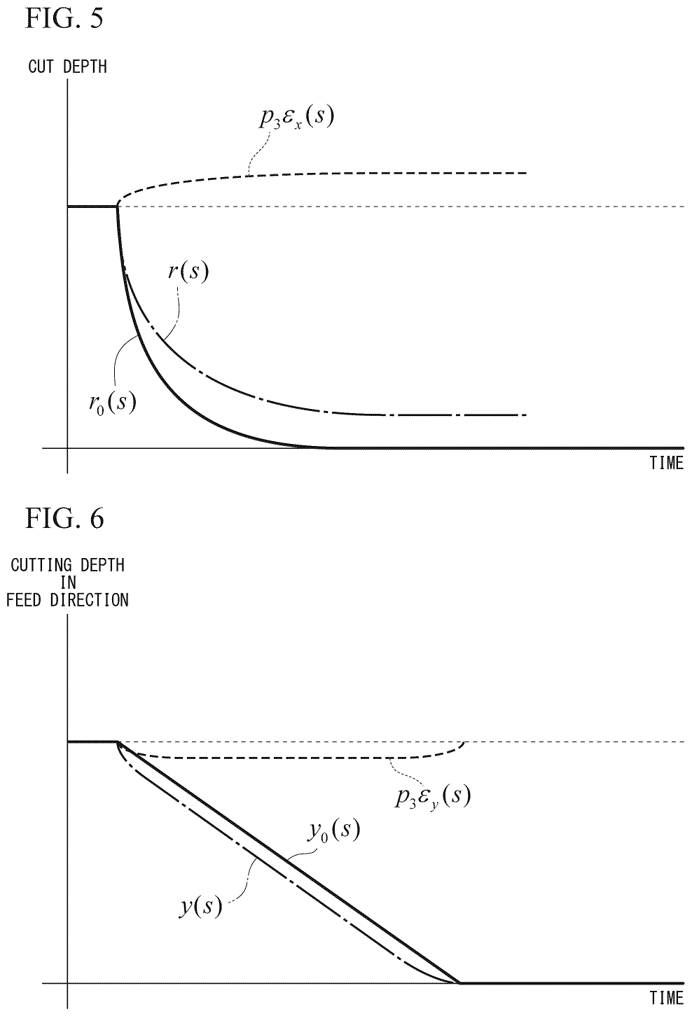

FIG. 5 is a diagram showing an example of a locus of the tool A (a locus of the cut depth) in a cutting direction according to the first embodiment. The cutting direction is referred to as a direction orthogonal to the axial direction of the tool A and a direction in which the tool A moves relative to the workpiece W. When the control unit 53 moves the tool A according to the cutting depth (target cutting depth) generated by the cutting depth determination unit 50, as shown in FIG. 5, deviation occurs between an actual locus of the tool A and a locus of the tool A according to the target cutting depth due to the flexure of the main shaft. Specifically, due to the flexing of the main shaft, the displacement of the actual cutting depth is delayed with respect to the target cutting depth, and the actual cutting depth does not reach the target cutting depth, resulting in the uncut portion. The flexure model representing the locus of the tool A in the cutting direction is represented by the following Equation (2).

$$\begin{matrix}( Equation 2 ) & \\ r ( s ) = \frac{{p}_{2}}{1 + {p}_{1} s} {r}_{0} ( s ) = \frac{1}{1 + {p}_{1} s} {r}_{0} ( s ) + {p}_{3} {ε}_{x} ( s ) & ( 2 )\end{matrix}$$

In Equation (2), s is a Laplace operator. r₀(s) is a function representing the locus of the cut depth when it is assumed that there is no flexure of the main shaft. The cut depth is the magnitude of a component of the cutting depth in the cutting direction. p₁ is a time constant representing a delay of the displacement of the tool A. p₂ is a coefficient representing the ratio of the compression amount of the main shaft to r₀(s). p₃ is a conversion coefficient for converting the magnitude of the flexure of the main shaft into a correction amount of the position of the tool A, that is, an amount of the uncut portion. εₓ(s) is a function representing a change in the flexure of the main shaft in the cutting direction.

FIG. 6 is a diagram showing an example of a locus of the tool A in a feed direction according to the first embodiment. The feed direction is referred to as a direction in which the tool A moves relative to the workpiece W. When the control unit 53 moves the tool A according to the target cutting depth, as shown in FIG. 6, deviation occurs between the actual locus of the tool A and the locus of the tool A according to the target cutting depth due to the flexure of the main shaft. Specifically, the blade of the tool A pushes the workpiece W by down cutting, so that the main shaft is bent forward in the feed direction and is displaced in the feed direction. In the feed direction, no uncut portion occurs at the time of removal of the tool A. The flexure model representing the locus of the main shaft in the feed direction is represented by the following Equation (3). ε_{y}(s) is a function representing a change in the flexure of the main shaft in the feed direction.

$$\begin{matrix}( Equation 3 ) & \\ \frac{1}{s} \{ sy ( s ) \} = \frac{1}{s} \{ \frac{1}{1 + {p}_{1} s} {sy}_{0} ( s ) + {p}_{3} s {ε}_{y} ( s ) \} & ( 3 )\end{matrix}$$

Hereinafter, a method of calculating the coefficient of the flexure model by the model generation unit 51 will be described.

Equation (4) can be obtained by modifying Equation (2).

$$\begin{matrix}( Equation 4 ) & \\ {ε}_{x} ( s ) = \frac{( 1 - {p}_{2} ) / {p}_{3}}{1 + {p}_{1} s} {r}_{0} ( s ) & ( 4 )\end{matrix}$$

The model generation unit 51 inputs the flexure &x obtained by the data acquisition unit 41 from the measurement value of the strain sensor 25S and the cutting depth r₀ calculated by the cutting depth determination unit 50 into Equation (4), and thus solves the problem of identification of the time constant pi and the gain {(1−p₂)/p₃}. Accordingly, the cutting depth determination unit 50 can calculate the time constant p₁ and the gain {(1−p₂)/p₃}. The model generation unit 51 inputs, into Equation (3), the flexure &y obtained by the data acquisition unit 41 from the measurement value of the strain sensor 25S, the derivative (that is, a feed speed) of the cutting depth y₀ in the feed direction calculated by the cutting depth determination unit 50, and the identified time constant p₁, and thus can calculate the coefficient p₃.

### (Operation of Control Board 40)

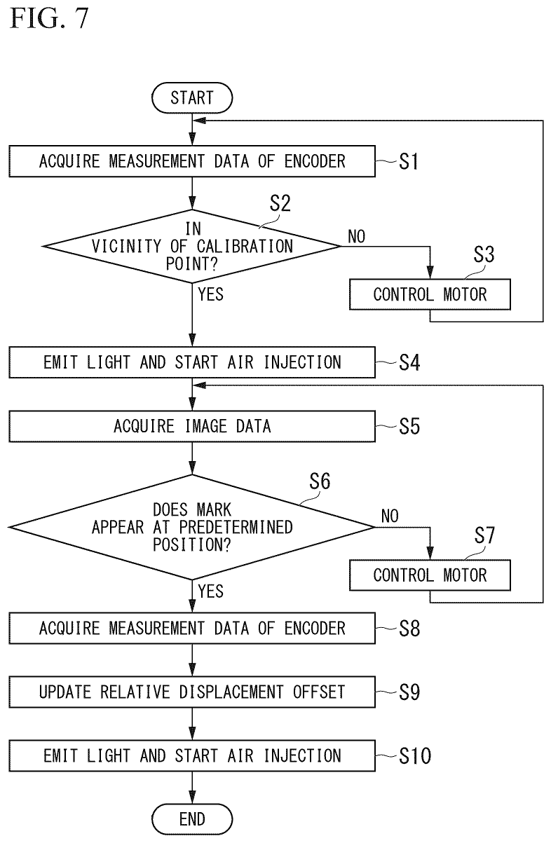

FIG. 7 is a flowchart showing a calibration operation of the control board 40 according to the first embodiment. In the example shown in FIG. 1, the table tab 27X is provided at a position that does not interfere with the workpiece W, and the head tab 25X is provided in a portion different from the attachment position of the tool A. As a result, the control board 40 can perform calibration in a state where the tool A and the workpiece W are placed, that is, immediately before machining.

When the machine main body 20 starts, the data acquisition unit 41 acquires the measurement data from the X-axis encoder 22E, the Z-axis encoder 23E, and the Y-axis encoder 24E (Step S1). The position determination unit 44 determines whether the main shaft head 25 and the work table 27 are positioned in the vicinity of predetermined calibration points based on the measurement data acquired in Step S1 (Step S2). That is, the position determination unit 44 determines whether the values of the X-axis encoder 22E, the Z-axis encoder 23E, and the Y-axis encoder 24E indicate the positions of the calibration points. When the main shaft head 25 and the work table 27 are not positioned in the vicinity of the predetermined calibration points (Step S2: NO), the control unit 53 controls the X-axis motor 22M, the Z-axis motor 23M, and the Y-axis motor 24M such that the main shaft head 25 and the work table 27 are positioned at the predetermined calibration points based on the measurement data acquired in Step S1 (Step S3). Thereafter, the control board 40 returns the process to Step S1.

When the main shaft head 25 and the work table 27 are positioned in the vicinity of the predetermined calibration points (Step S2: YES), the control unit 53 causes the headlight 11 and the table light 12 to emit light and starts the air injection from the air nozzle 13 (Step S4). The data acquisition unit 41 acquires image data from the head camera 33 and the table camera 34 (Step S5). The displacement correction unit 45 determines whether the mark of the head tab 25X and the mark of the table tab 27X appearing in the image data acquired in Step S5 appear at a predetermined position (for example, the center of the image) of the image data and in a predetermined size (Step S6). That is, the displacement correction unit 45 stores in advance the shapes of the head tab 25X and the table tab 27X when the main shaft head 25 and the work table 27 are positioned at the calibration points, and determines whether the head tab 25X and the table tab 27X appearing in the image data match the shapes. When the head tab 25X or the table tab 27X does not appear at a predetermined position and in a predetermined size (Step S6: NO), the control unit 53 controls the X-axis motor 22M, the Z-axis motor 23M, and the Y-axis motor 24M so as to reduce a shape error (Step S7). Then, the control board 40 returns the process to Step S5.

Meanwhile, when the head tab 25X and the table tab 27X appear at predetermined positions and in predetermined sizes (Step S6: YES), the data acquisition unit 41 acquires the measurement data from the X-axis encoder 22E, the Z-axis encoder 23E, and the Y-axis encoder 24E (Step S8). The displacement correction unit 45 calculates, as a relative displacement offset, a difference between the values of the X-axis encoder 22E, the Z-axis encoder 23E, and the Y-axis encoder 24E set as the positions of the calibration points and the measurement data acquired in Step S8, and stores the difference in the parameter storage unit 43 (Step S9). Then, the control unit 53 causes the headlight 11 and the table light 12 to end emitting light, and ends the injection of the air from the air nozzles 13 (Step S10). Thereby, the control board 40 can fast perform the calibration of the relative displacement between the main shaft head 25 and the work table 27. In the machining center 1 according to another embodiment, the headlight 11 and the table light 12 may emit light all the time, or the air nozzle 13 may inject air all the time. That is, the control board 40 according to another embodiment may not execute the processes of Step S4 and Step S10.

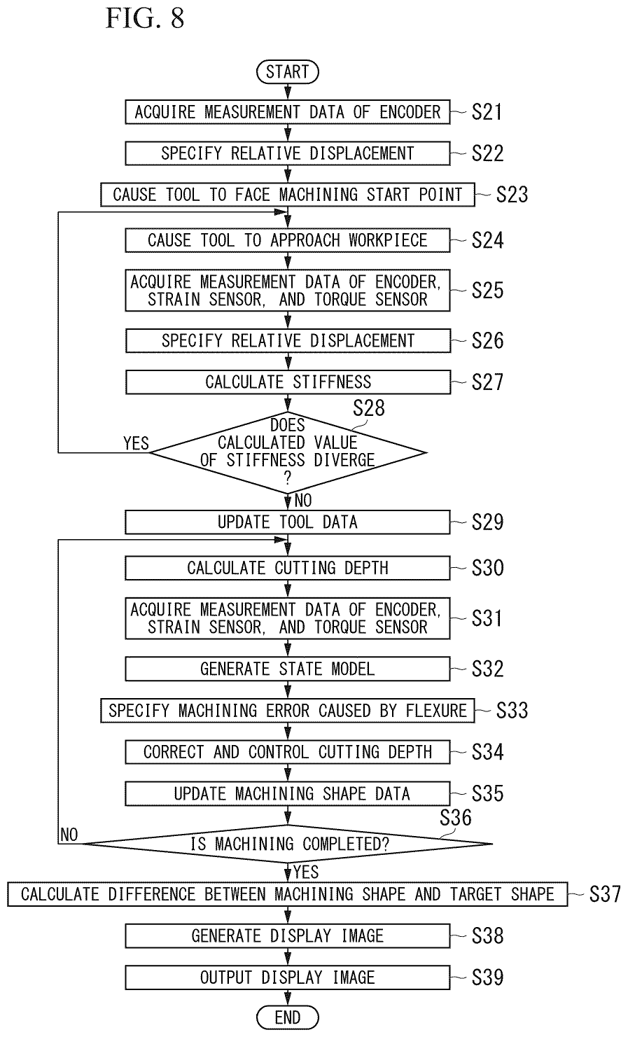

FIG. 8 is a flowchart showing a machining operation by the control board 40 according to the first embodiment.

After the calibration of the machine main body 20 is completed, the control board 40 starts machining of the workpiece W. The operator stores initial shape data and target shape data in the shape storage unit 42 before starting the machining.

When the control board 40 starts the machining, the data acquisition unit 41 acquires the measurement data from the X-axis encoder 22E, the Z-axis encoder 23E, and the Y-axis encoder 24E (Step S21). The relative displacement-specifying unit 46 specifies the relative displacement between the main shaft head 25 and the work table 27 based on the acquired measurement data and the relative displacement offset stored in the parameter storage unit 43 (Step S22). The control unit 53 determines a machining start point of the workpiece W based on the target shape data, and controls the X-axis motor 22M and the Y-axis motor 24M such that the tool A faces the machining start point of the workpiece W based on the relative displacement specified in Step S22 (Step S23).

Next, the control unit 53 controls the Z-axis motor 23M such that the tool A approaches the workpiece W by a predetermined amount (Step S24). The data acquisition unit 41 acquires the measurement data from the X-axis encoder 22E, the Z-axis encoder 23E, the Y-axis encoder 24E, the strain sensor 25S, and the torque sensor 26T (Step S25). The relative displacement-specifying unit 46 specifies the relative displacement between the main shaft head 25 and the work table 27 (Step S26). The stiffness calculation unit 47 calculates the stiffness of the main shaft based on the measurement data of the strain sensor 25S and the torque sensor 26T acquired in Step S25 (step S27). The contact determination unit 48 determines whether the stiffness value calculated in Step S27 diverges (Step S28).

When the stiffness value diverges (Step S28: YES), the control board 40 returns the process to Step S24. Meanwhile, when the stiffness value does not diverge (Step S28: NO), the tool data correction unit 49 specifies the tool length based on the relative displacement calculated in Step S26 and the initial shape data stored in the shape storage unit 42 (Step S29), and updates the tool data stored in the parameter storage unit 43.

Next, the cutting depth determination unit 50 calculates the cutting depth of the workpiece W based on the relative displacement between the main shaft head 25 and the work table 27 specified by the relative displacement-specifying unit 46 and the target shape data stored in the shape storage unit 42 (Step S30). The data acquisition unit 41 acquires the measurement data from the X-axis encoder 22E, the Z-axis encoder 23E, the Y-axis encoder 24E, and the strain sensor 25S (Step S31). The model generation unit 51 generates a state model based on the cutting depth calculated in Step S30 and the measurement data of the strain sensor 25S (Step S32). That is, the model generation unit 51 generates the state model such that the state model outputs the time constant p₁ representing the delay in the displacement due to the flexure, the conversion coefficient p₃ for converting the magnitude of the flexure of the main shaft into the correction amount of the position of the tool A, that is, the amount of the uncut portion, and the cutting depth. The error-specifying unit 52 converts the magnitude of the flexure of the main shaft into the amount of deviation of the position of the tool A, that is, the amount of uncut portion by using the state model stored in the parameter storage unit 43. That is, the machining error caused by the flexure is specified (Step S33). As a result, the difference between the instructed cutting depth and the actual cutting depth, that is, the machining error is known.

The control unit 53 corrects the cutting depth based on the cutting depth calculated in Step S30 and the error calculated in Step S33, and controls each actuator based on the tool length stored in the parameter storage unit 43 (Step S34). The finished shape generation unit 54 updates the machining shape data based on the measurement data acquired in Step S31 (Step S35).

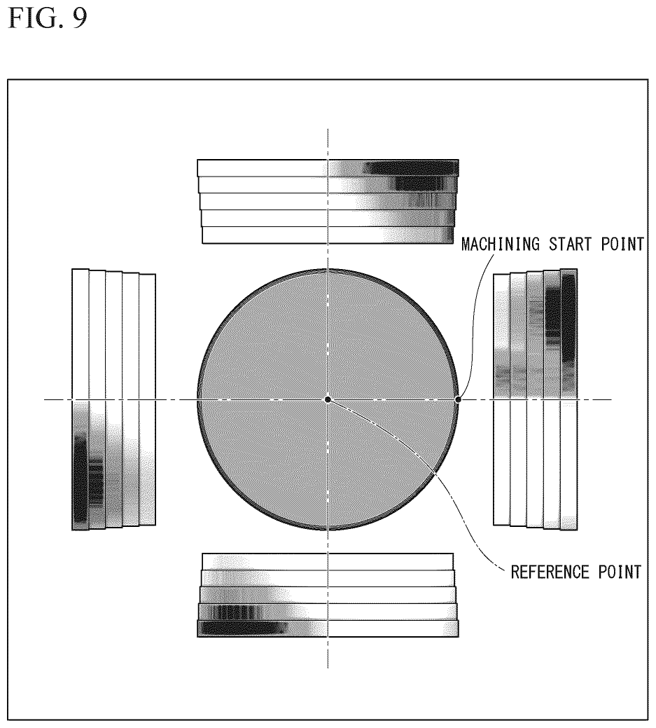

The control unit 53 determines whether the machining of the workpiece W is completed (Step S36). When the machining of the workpiece W is not completed (Step S36: NO), the control board 40 returns the process to Step S30. Meanwhile, when the machining of the workpiece W is completed (Step S36: YES), the display control unit 55 calculates the difference between the machining shape data stored in the shape storage unit 42 and the target shape data (Step S37). The display control unit 55 maps a color corresponding to the difference calculated in Step S37 on the surface of the machining shape data and renders the machining shape data to generate a display image (Step S38). FIG. 9 is a diagram showing an example of the display image according to the first embodiment. Specifically, as shown in FIG. 9, the display control unit 55 generates a display image including a color map representing, by color, the difference between the distance from the reference point of the workpiece W to the surface of the machining shape data and the distance from the reference point to the surface of the target shape data. The display control unit 55 outputs the display image to the display (Step S39). The color corresponding to the difference may be, for example, red in an insufficiently machined portion, blue in an excessively machined portion in blue, and a gradation by which the magnitude of the difference is shown. The reference point according to the example shown in FIG. 9 is an axial point extending in the Z-axis direction passing through the center of the workpiece W. According to the example shown in FIG. 9, it can be seen that a step occurs at the machining start point of the workpiece W.

Meanwhile, the reference point according to another embodiment may be a point on a plane obtained by offsetting an XY plane in the Z-axis direction, or may be a point on the rotation axis of the work table 27. The reference points may be switchable by, for example, the operation of the user.

As a result, the control board 40 can correct the machining error while machining the workpiece W, and allow the operator to visually recognize the difference between the finished product and the target shape.

### (Action and Effect)

In this way, the control board 40 according to the first embodiment corrects the tool length data based on the relative displacement between the main shaft head 25 and the work table 27 and the measurement values of the flexure of the tool. That is, the control board 40 can detect contact between the workpiece W and the tool A during machining of the workpiece W, and can correct the tool length data based on this. As a result, the control board 40 can correct the machining error due to the tool length while machining the workpiece W.

The head camera 33 and the table camera 34 according to the first embodiment are supported by the independent pedestal 31 without coming into contact with the housing 10 or the machine main body 20. Accordingly, even when the machine main body 20 vibrates due to the operation, the positional deviation of the head camera 33 and the table camera 34 can be prevented. Accordingly, it is possible to prevent deterioration in the accuracy of correcting the relative displacement between the main shaft head 25 and work table 27 based on the image captured by the head camera 33 and the table camera 34.

When the machining is controlled according to numerical control (NC) data generated from the target shape data without correcting the relative displacement, due to the effects of displacement or the like caused by heat and gravity, an error in the position of the tool appears as it is as the machining error. In addition, the relative displacement of the head camera 33 and the table camera 34 is fixed by the top plate 32. Therefore, by using the images captured by the head camera 33 and the table camera 34 as references to correct the relative displacement between the main shaft head 25 and the work table 27, the machining error can be reduced. The control board 40 according to the first embodiment corrects the relative displacement by driving the actuators such that the head tab 25X and the table tab 27X appear in predetermined shapes in the captured image. By correcting the relative displacement between the main shaft head 25 and the work table 27 using the image, the control board 40 cannot only correct the relative translation amount but can also correct the rotation angle, that is, the deviation of the relative attitude.

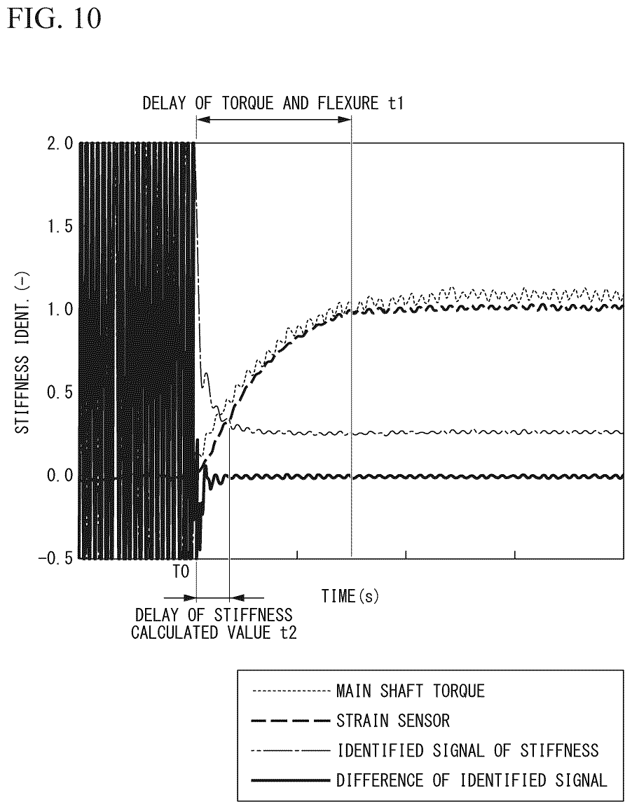

The control board 40 according to the first embodiment calculates the stiffness based on the torque of the tool A and the flexure of the main shaft, and determines the contact between the tool A and the workpiece W based on the calculated value. FIG. 10 is a graph showing the relationship between measurement values of torque and flexure and the calculated value of stiffness. As shown in FIG. 10, there is a delay from the contact between the workpiece W and the tool A to the significant change in the measurement values of the torque of the main shaft and the flexure of the main shaft. For example, in the example shown in FIG. 10, the workpiece W and the tool A come into contact at a time T0. The measurement values of the torque of the main shaft and the flexure of the main shaft change due to the contact between the workpiece W and the tool A, and reach a steady state after a time t1 has elapsed from the contact between the workpiece W and the tool A. That is, there is a delay of the time t1 from the contact between the workpiece W and the tool A until the measurement values of the torque of the main shaft and the flexure of the main shaft significantly change. Meanwhile, the calculated value of the stiffness converges after a time t2 has elapsed from the contact between the workpiece W and the tool A. As shown in FIG. 10, it can be seen that the time t2 is significantly shorter than time t1. Specifically, the time t2 is approximately one-fifth of the time t1. From this, it can be seen that the calculated value of the stiffness is highly sensitive to the contact between the workpiece W and the tool A. Therefore, the control board 40 according to the first embodiment can perform contact determination without delay by using the calculated value of the stiffness.

The control board 40 according to the first embodiment calculates the flexure of the main shaft based on the measurement value of the strain sensor 25S provided on the notch fulcrum of the elastic hinge 25H. The stress caused by the flexure of the main shaft head 25 between the two fixing portions of the elastic hinge 25H is concentrated on the notch fulcrum of the elastic hinge 25H. As a result, the elastic hinge 25H can convert a small displacement of the main shaft head 25 into a large strain of the notch fulcrum. Therefore, it is possible to significantly improve the sensitivity of the strain sensor 25S. For example, in a case where the length between the notches at both end portions of the elastic hinge 25H is 150 mm, the magnitude of the strain generated in the notch fulcrum in the central portion of the elastic hinge 25H is about 25 times the strain generated in the main shaft head 25 itself. By providing the elastic hinge 25H and the strain sensor 25S on the main shaft head 25, the strain of the tool A can be measured even when the machining center 1 performs the automatic exchange of the tool A.

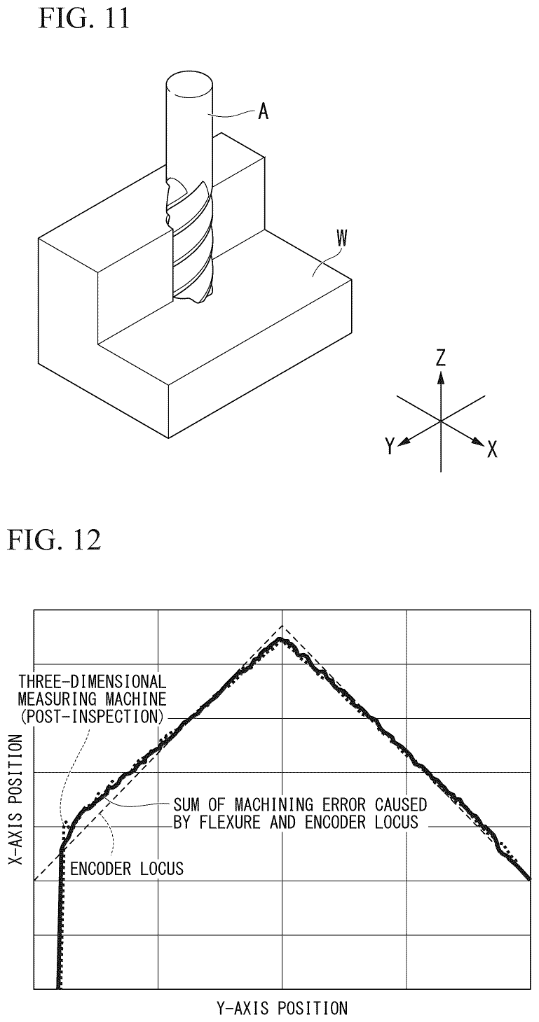

The control board 40 according to the first embodiment generates the state model for calculating the state of the machine main body 20 based on the measurement values of the machine main body 20 and the cutting depth, and specifies the machining error from the measurement value of the strain sensor 25S based on the state model. As a result, the control board 40 can correct the machining error while machining the workpiece W. A tip portion of the tool A cannot be observed with a camera or the like due to the presence of sparks, chips, and coolant during machining of the workpiece W, but according to the control board 40 of the present embodiment, the state of the tip of the tool A can be recognized regardless of the presence or absence of these. FIG. 11 is a diagram showing an example of side machining of the workpiece W. According to FIG. 11, the machine main body 20 machines the side surface of the workpiece W along the Y-axis with the tool A. In this case, the main shaft comes into contact with the side surface of the workpiece W, thereby bending in the X-axis direction. FIG. 12 is a diagram showing the measurement results of the machining shape of the workpiece due to the side machining. As shown in FIG. 12, it can be seen that the sum of the machining error specified from the state model and the encoder locus during the side machining substantially matches the machining shape measured using a three-dimensional measuring machine after the side machining. That is, according to the present embodiment, the control board 40 can present the machining error with high accuracy without measuring the machining error in a post-process.

### Other Embodiments

Although one embodiment has been described in detail above with reference to the drawings, the specific configuration is not limited to the one described above, and various design changes and the like can be made. That is, in other embodiments, the order of the processes described above may be changed as appropriate. Some processes may be executed in parallel.

The control board 40 according to the above-described embodiment may be configured by a single computer, or the configuration of the control board 40 may be arranged to be divided into a plurality of computers, and the plurality of computers may function as the control board 40 by cooperating with each other. In this case, some of the computers constituting the control board 40 may be mounted inside the machining center 1, and the other computers may be provided outside the machining center 1.

Although the control board 40 according to the above-described embodiment controls the machining center 1, the present disclosure is not limited to this. For example, a control board 40 according to other embodiments may control other machine tools such as grinders, milling machines, lathes, and drilling machines.

The control board 40 according to the above-described embodiment detects the flexure of the main shaft by the flexure of the main shaft head 25 detected by the strain sensor 25S provided in the elastic hinge 25H, but the present disclosure is not limited to this. For example, a control board 40 according to another embodiment may detect the flexure of the main shaft by an acceleration sensor attached to the spindle 26 or a displacement sensor measuring a displacement of a tool attachment portion of the spindle 26. The flexure of the main shaft includes the deviation from the axis of the machining point at the tip of the main shaft.

While the flexure of the main shaft is shown by the displacement of the tool attachment portion of the spindle 26, the magnitude of the displacement is small, and the detection by the displacement sensor may be difficult. However, a large measurement value can be obtained by measuring the flexure by using the combination of the elastic hinge 25H and the strain sensor 25S as in the first embodiment. Meanwhile, the presence or absence of the contact between the tool A and the workpiece W can be easily detected even by a small measurement value by the displacement sensor because the stiffness identification calculation is performed.

In the above-described embodiment, the head camera 33 is provided on the side of the main shaft head 25. However, the present disclosure is not limited thereto, and in another embodiment, the head camera 33 may be attached to a ceiling of the housing 10 and may be positioned right above the main shaft head 25. In the above-described embodiment, the table camera 34 is provided on the side of the table 23. However, the present disclosure is not limited thereto, and in another embodiment, the table camera 34 is attached to the ceiling of the housing 10 and may be positioned right above the table 23. In this case, as in the first embodiment, the head camera 33 and the table camera 34 are preferably fixed by a jig made of a material that is less likely to thermally expand. An example of a material that is less likely to thermally expand includes ceramics or the like. In another embodiment, a plurality of head cameras 33 and table cameras 34 may be provided, and the control board 40 may perform calibration based on images captured by these camera.

### (Computer Configuration)

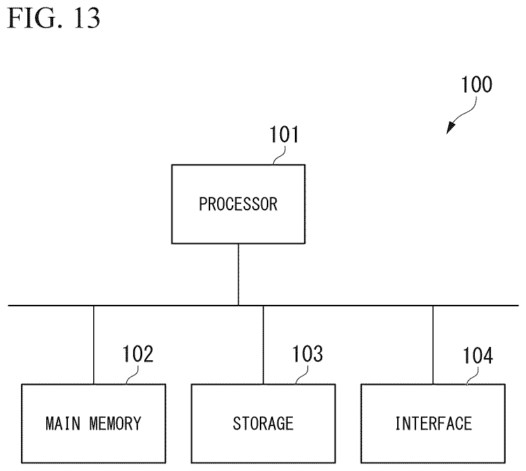

FIG. 13 is a schematic block diagram showing a configuration of a computer according to at least one embodiment.

A computer 100 includes a processor 101, a main memory 102, a storage 103 and an interface 104.

The control board 40 described above is implemented in the computer 100. The operation of each processing unit described above is stored in the storage 103 in the form of a program. The processor 101 reads a program from the storage 103, loads the program in the main memory 102, and executes the above processes according to the program. The processor 101 secures storage areas corresponding to the storage units described above in the main memory 102 according to the program. An example of the processor 101 includes a central processing unit (CPU), a graphic processing unit (GPU), a microprocessor, and the like.

The program may be for realizing part of the functions that the computer 100 is caused to exhibit. For example, the program may function in combination with another program already stored in the storage or in combination with another program implemented in another device. In another embodiment, the computer 100 may include a custom large scale integrated circuit (LSI) such as a programmable logic device (PLD) in addition to or instead of the above configuration. An example of the PLD includes a programmable array Logic (PAL), a generic array logic (GAL), a complex programmable logic device (CPLD), and a field programmable gate array (FPGA). In this case, some or all of the functions realized by the processor 101 may be realized by such an integrated circuit. Such an integrated circuit is also included in an example of a processor.

An example of the storage 103 includes a magnetic disk, a magneto-optical disk, an optical disk, a semiconductor memory, and the like. The storage 103 may be an internal medium directly connected to a bus of the computer 100, or an external medium connected to the computer 100 via the interface 104 or a communication line. When this program is distributed to the computer 100 via a communication line, the computer 100 receiving the distribution may load the program in the main memory 102 and execute the above processes. In at least one embodiment, the storage 103 is a non-transitory, and material storage medium.

The program may be for realizing some of the functions described above. The program may be a so-called difference file (difference program) that realizes the above-described functions in combination with another program already stored in the storage 103.

According to the above aspects. the control device can correct a machining error while machining a workpiece.

1. A control device of a machine, the machine including a jig and a main shaft, the jig being configured to support a workpiece, the main shaft including a tool that machines the workpiece, the control device comprising:
a relative displacement-specifying unit configured to specify a relative displacement between the jig and the tool based on measurement values of displacements of the jig and the tool;
a position determination unit configured to determine whether the jig and the tool are respectively positioned at a jig calibration point and a tool calibration point based on the measurement values of the displacements of the jig and the tool;
a displacement correction unit configured to correct the measurement values of the displacements of the jig and the tool based on a captured image of the jig calibration point and a captured image of the tool calibration point imaged by a camera supported by a support that does not come into contact with the machine when it is determined that the jig and the tool are respectively positioned at the jig calibration point and the tool calibration point;
a contact determination unit configured to determine whether the tool comes into contact with the workpiece based on a measurement value related to flexure of the main shaft;
a tool data correction unit configured to correct tool data indicating a length of the tool based on the relative displacement when it is determined that the tool comes into contact with the workpiece; and
a control unit configured to generate a control command useable to control the jig or the tool based on the relative displacement, a shape of the workpiece, and the tool data.

2. A control device of a machine, the machine including a jig and a main shaft, the jig being configured to support a workpiece, the main shaft including a tool that machines the workpiece and a head that supports the tool, the control device comprising:
a relative displacement-specifying unit configured to specify a relative displacement between the jig and the tool based on measurement values of displacements of the jig and the tool;
a contact determination unit configured to determine whether the tool comes into contact with the workpiece based on a measurement value related to flexure of the main shaft;
a tool data correction unit configured to correct tool data indicating a length of the tool based on the relative displacement when it is determined that the tool comes into contact with the workpiece; and
a control unit configured to generate a control command useable to control the jig or the tool based on the relative displacement, a shape of the workpiece, and the tool data,
the head being provided with
a hinge member connecting a distal portion and a proximal portion of the head to each other, and
a strain sensor provided to straddle a rotation axis of the hinge member, and
the contact determination unit being configured to determine whether the tool comes into contact with the workpiece based on a measurement value of the strain sensor.

3. The control device according to claim 2, wherein
the hinge member is formed of a material having a same linear expansion coefficient as a linear expansion coefficient of the head.

4. The control device according to claim 1, wherein
the tool data indicates a diameter of the tool in addition to the length of the tool.

5. The control device according to claim 1, further comprising:
a model generation unit configured to generate a state model useable to calculate a state of the machine based on a measurement value related to the machine and the control command; and
an error-specifying unit configured to specify a machining error by inputting the measurement value related to the machine into the state model,
the state model being a model useable to obtain a position of the tool based on the control command and the measurement value related to the flexure of the main shaft, and
the model generation unit being configured to obtain, the generate the state model,
a time constant indicating a delay in displacement due to flexure based on the flexure of the main shaft in a cutting direction and
a conversion coefficient useable to convert a magnitude of flexure into a correction amount of the position of the tool based on the flexure of the main shaft in a feed direction and the time constant.

6. The control device according to claim 5, further comprising:
a finished shape generation unit configured to generate three-dimensional data representing the shape of the workpiece machined by the control command based on the machining error; and
a map generation unit configured to generate a color map in which a difference is represented by a color, the difference being between
a distance from a reference point of the workpiece to a surface of the three-dimensional data and
a distance from the reference point to a surface of a target shape of the workpiece,
the control unit being configured to generate the control command based on target data representing the target shape.

7. An industrial machine including the control device according to claim 1, the industrial machine further comprising:
the jig configured to support the workpiece; and
the tool configured to machine the workpiece.

8. A control method of a machine, the machine including a jig and a main shaft, the jig being configured to support a workpiece, the main shaft including a tool that machines the workpiece, the control method comprising:
specifying a relative displacement between the jig and the tool based on measurement values of displacements of the jig and the tool;
determining whether the jig and the tool are respectively positioned at a jig calibration point and a tool calibration point based on the measurement values of the displacements of the jig and the tool;
correcting the measurement values of the displacements of the jig and the tool based on a captured image of the jig calibration point and a captured image of the tool calibration point imaged by a camera supported by a support that does not come into contact with the machine when it is determined that the jig and the tool are respectively positioned at the jig calibration point and the tool calibration point;
determining whether the tool comes into contact with the workpiece based on a measurement value related to flexure of the main shaft;
correcting tool data indicating a length of the tool based on the relative displacement when it is determined that the tool comes into contact with the workpiece; and
generating a control command useable to control the jig or the tool based on the relative displacement, a shape of the workpiece, and the tool data.

9. A control method of a machine, the machine including a jig and a main shaft, the jig being configured to support a workpiece, the main shaft including a tool that machines the workpiece and a head that supports the tool, the head being provided with a hinge member and a strain sensor, the hinge member connecting a distal portion and a proximal portion of the head to each other, the strain sensor being provided to straddle a rotation axis of the hinge member, the control method comprising:
specifying a relative displacement between the jig and the tool based on measurement values of displacements of the jig and the tool;
determining whether the tool comes into contact with the workpiece based on a measurement value of the strain sensor,
correcting tool data indicating a length of the tool based on the relative displacement when it is determined that the tool comes into contact with the workpiece; and
generating a control command useable to control the jig or the tool based on the relative displacement, a shape of the workpiece, and the tool data.
